(19) United States
(12) Patent Application Publication
(10) Pub. No.: US 2008/0219944 A1
(43) Pub. Date: Sep. 11, 2008

(54) Polymer based antifouling coating

(75) Inventors: Frank N. Longo, East Northport, NY (US); Thomas Gardega, Conway, SC (US)

Correspondence Address: DILWORTH & BARRESE, LLP, 333 EARLE OVINGTON BLVD., SUITE 702, UNIONDALE, NY, 11553, US

(73) Assignee: XIOM CORPORATION, West Babylon, NY (US)

(21) Appl. No.: 11/900,508

(22) Filed: Sep. 12, 2007

Related U.S. Application Data
(60) Provisional application No. 60/844,476, filed on Sep. 14, 2006.

(51) Int. Cl. C09D 5/16

(52) U.S. Cl. 424/78.09

(57) ABSTRACT

A coating composition comprising (i) at least one resin powder and (ii) at least one component selected from the group consisting of a metal compound, biocide and fluoropolymers. In particular, one antifouling composition that can be used on underwater stationary structures that sit in highly fouling environments comprises polyethylene as a resin powder, and copper in the form of cuprous or cupric oxide.

### CROSS REFERENCE TO RELATED APPLICATIONS

This application claims priority to U.S. provisional application Ser. No. 60/844,476 filed Sep. 14, 2006, which is herein incorporated by reference.

### FIELD OF THE INVENTION

The present invention relates to coating compositions, in particular to antifouling coating compositions and films formed therefrom. In addition the present invention is directed to methods for producing antifouling coatings wherein the antifouling coating composition is used. The invention is also directed to a marine vessels (hull) or underwater structures coated with coatings of the present invention.

More particularly, the present invention relates to an antifouling coating composition that can be formed into an antifouling composition suitable for thermal spraying techniques. From the antifouling thermal spray composition, there can be obtained an antifouling coating film which exhibits less cracking tendency, excellent adherence so as to ensure less peeling tendency and a desirably controlled hydrolysis rate so as to provided prolonged excellent antifouling performance (antifouling activity). The present compositions are especially suited for underwater structures that mostly remain in a mildly or highly fouling environment. For example, on mobile vessels as well as, stationary components such as piers. Further, the present invention relates to an antifouling coating film formed from the antifouling coating composition, an antifouling method wherein the antifouling coating composition is used, and a hull or underwater structure covered with the coating film.

### BACKGROUND OF THE INVENTION

Ship bottoms/hulls, underwater structures, fishing nets and the like are likely to have their appearance and function damaged by the adhesion to surface and propagation of various aquatic organisms including animals such as shellfishes, hard-shelled mussels, such as Zebra mussels, and barnacles, plants such as laver (seaweeds) and bacteria which is caused when they are exposed to water for a prolonged period of time.

In particular, when any one or more of the aquatic organisms mentioned above adheres to a ship's bottom and propagates, the surface becomes rough and the friction of the ship in the water increases thereby lowering the speed of the ship and increasing fuel consumption of the ship. Removing the aquatic organisms from the ship bottom is labor intensive and costly. When bacteria adhere to underwater structures and propagate and slime (sludgy matter) adheres thereto putrefaction may occur. In addition, when marine growth adheres to the surface of an underwater structure, for example, steel structure and propagates damage of the corrosion preventive coating is in danger of deterioration and the life of the underwater structure will be drastically reduced.

It is common practice to apply, for example, a composition comprising a copolymer of tributyltin methacrylate and methyl methacrylate or the like and cuprous oxide (Cu₂O) as an antifouling paint having excellent antifouling properties to ship bottoms, etc. so as to avoid the above damages. This copolymer of the antifouling paint is hydrolyzed in the seawater to thereby liberate organotin compounds such as bistributyltin oxide (tributyltin ether of the formula Bu₃ Sn—O—SnBu₃ wherein Bu is a butyl group) and tributyltin halides (Bu₃ SnX wherein X is a halogen atom), so that an antifouling effect is exerted. Furthermore, the copolymer hydrolyzate per se is a “hydrolysable self-polishing paint” which is rendered water-soluble and thus is dissolved in the seawater, so that no resin residue is left on the surface of the ship bottom coating with the result that always an active surface can be maintained.

However, the above organotin compounds are so highly toxic that apprehensions are being entertained with respect to marine pollution, occurrence of anomalous fish and anomalous shellfish and adverse effects on ecosystem through food chain. Therefore, the development of a nonstannic antifouling paint is desired as a substitute therefore.

For example, antifouling paints available today suffer from many problems. One problem is that their antifouling capabilities, the main reason they are used, are poor or have a short protective life and cracking/peeling of the antifouling paint often occurs.

Another problem often experienced with existing anti-fouling compositions is their poor storage stability, and the coating film obtained from the antifouling paint has a drawback in that the cracking resistance thereof is not fully satisfactory. Still another problem that is experienced with carboxylic based antifouling coatings is that these coating have a tendency to gel during the storage thereof and that the coating film formed from the antifouling paint is poor in cracking and peeling resistances.

Some antifouling compositions available on the market today contain compounds having silicon (Si) groups. These silicon compounds, usually having an alkoxy group (C), when water is present in the paint, induces a hydrolytic reaction with the water to thereby become an alcohol. Thus, an adverse influence on an increase of water in the paint and coating film is apprehended. Moreover, the silanol after the hydrolysis poses such a problem that silanol molecules undergo a condensation reaction to thereby reproduce water. This process makes the coating film obtained from the coating composition inferior in that the coating is subject to cracking resistance and antifouling properties, especially, antifouling properties in a stationary environment or highly fouling environment.

Other antifouling agents are available on the market that contain organic compounds such as cuprous oxide (Cu₂O), cupric oxide (CuO) copper powder and other copper compounds, zinc sulfate and zinc oxide, and further mentioned organometallic compounds such as oxine copper and other organocopper compounds, organonickel compounds, and zinc pyrithione as well as other organozinc compounds. However, these paints mostly share one common drawback, the active ingredient leaches from the composition either too slowly so that it provides as poor antifouling properties or too fast that the composition does not retain its antifouling for a long enough period to be an economically feasible solution.

However, with respect to the paints and coating films available on the market today, many of the paints exhibit at least one major drawback selected from the group consisting of unsatisfactory storage stability, unsatisfactory cracking resistance, excessive peeling poor adherence of coating film to the surface to be coated, unsatisfactory antifouling performance, in particular, antifouling properties in stationary environment, long-term antifouling properties and self-polishing properties.

Therefore, in view of the foregoing, what is needed is an antifouling composition that has superior antifouling properties, strong surface attachment, resistance to cracking and peeling and is able to be stored without losing any of its antifouling properties. The present invention described below is a thermally sprayable composition that has a molecular structure when applied that imparts excellent antifouling properties for an extended period of time and resist cracking and peeling away from the surface in which it is applied. In other words, the present invention overcomes many of the problems associated with antifouling agents available on the market today.

### OBJECT OF THE INVENTION

The present invention has been made with a view toward solving the above problems of the prior art. It is an object of the present invention to provide an antifouling coating composition capable of forming an antifouling coating film which exhibits less cracking tendency, excellent adherence so as to ensure less peeling tendency and desirably controlled hydrolysis rate so as to be excellent in antifouling performance (antifouling activity), in particular, antifouling properties in highly fouling environment and long-term antifouling properties, which antifouling coating composition is excellent in storage stability, and can be thermally sprayed to provide an uniform thick film quickly and easily.

It is another object of the present invention to provide an antifouling coating film formed from the above antifouling coating composition, an antifouling method wherein the antifouling coating composition is used, and a hull or underwater structure covered with the coating film.

### SUMMARY OF THE INVENTION

The present invention is directed to a thermally sprayable coating composition comprising at least one resin powder, and at least one component selected from the group consisting essentially of metal compound (as an active ingredient), biocide (as an active ingredient) and fluoropolymer. Thermal spraying includes all powder and wire-processing equipment using a heat source or electric arch to melt and project melt particles to form a coating. For example, in plasma spraying, high velocity oxygen fuel, low velocity to project the particle to low heat to coat a surface. Cold spraying is a process using high velocity particle accelerate to form a coating using minimal heat. The component or components from the group described above being clad to less than all of the resin powder so as to leave at least a portion of the resin powder unclad. The composition of the present invention may also contain a binding solution for cladding the components of the listed group to said resin.

Another aspect of the present invention is directed to a coating film formed from the coating composition described above.

Yet another aspect of the present invention is directed to a marine vessel, an underwater structure, fishing gear or fishing net, having a surface covered with the antifouling coating film formed from the coating composition described above.

Still yet another aspect of the invention is directed to a method of rendering a surface antifouling comprising applying the thermally sprayable polymer coating composition described above in a manner so as to coat at least a portion of the surface to be protected with the coating of the present invention.

### BRIEF DESCRIPTION OF THE DRAWINGS

FIG. 1 shows the active ingredients clad together and attached to a resin of the present composition.

FIG. 2 shows the continuing leaching path of the active ingredients around the resin in a surface coated with the composition of the present invention.

### DETAILED DESCRIPTION OF THE INVENTION

The present invention is directed to thermally sprayable polymer-based coating compositions. In particular, the present invention is directed to anti-fouling compositions designed for thermally spraying, containing a resin and at least one other component. The other component can be selected from the group consisting of metal containing compounds, biocides, fluoropolymers and a binding solution. In one particular embodiment of the invention, the binding solution used in preparing the coating composition of the present invention is water-based. In order to obtain sufficient density and to assure long lasting release of the active ingredients of the composition, the active metal components and/or biocides and/or fluoropolymers are clad to less than all of the resin powder particles in the composition of the invention.

The incomplete cladding can be achieved by providing the correct stoichiometric mixture of components. In other words, in making the composition of the present invention more resin powder by volume is used than the powdered cladding components listed above. This assures that the resulting composition of the invention contains resin powder particles that are incompletely clad as well as unclad resin particles. The partially cladded portion of the resin particles in the composition will melt first during the thermal spraying process carrying with it the metal ions or other components having a higher melt point than the unclad portion of resin particles. Once melted, the melted particles of the composition of the present invention adhere to the surface being coated. It is important to make sure that the resin particles are incompletely cladded so as to allow this process to occur and prevent the fully cladded material as acting as a thermal barrier.

Once applied to the surface, the thermally sprayed composition traps the clad metal/biocide ingredients within the numerous crevices/fissures created from the spaces between each of the larger resin molecules of the composition. This specific arrangement of molecules allows for the applied coating to readily provide active ingredients such as, metal/biocide material, so as to prevent marine life (such as barnacles, mussels, sea grass etc) from attaching and growing on the surface once it is submerged underwater. This specific arrangement also provides a reservoir of active particles that are positioned within the crevices/fissures described above, but behind the active particles presented at the surface. Once the active particles at the surface are completed, additional active particles can leach through the maze of crevices/fissures and eventually replenish the active particle depleted. In other words, the composition of the present invention provides an antifouling coating that slowly leaches active components to its surface as the active components are depleted.

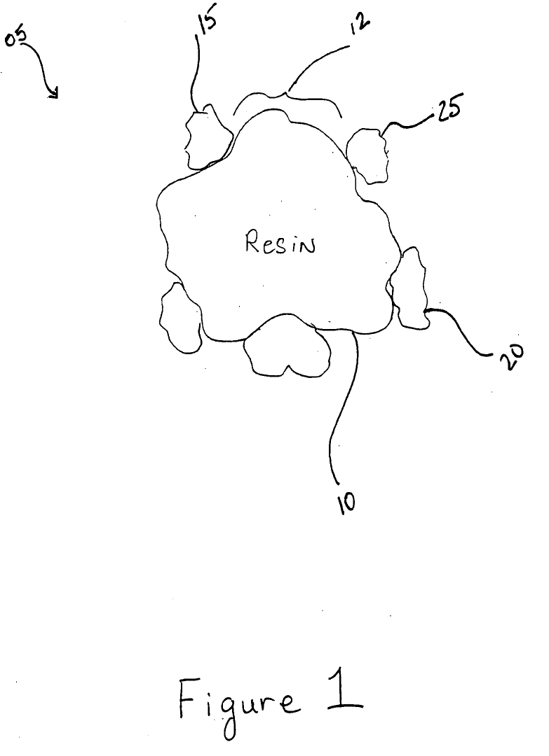

FIG. 1 illustrates one embodiment of a clad particle of the composition of the present invention (05). In the clad particle (05) the resin (10) is clad to a metal component (15) a biocide (20) and a fluoroploymer (25). It is understood from the present disclosure that not every resin particle will have the same number of particles and types attached. The resin (10) molecule is partially clad and has at least a portion of the surface of the resin (10) unclad (12). As mentioned above, this arrangement facilitates the melting of the particles in the thermal spraying process and allows the particles to adhere to the surface while capturing and adhering the remaining particles to the surface to which it is being applied. Should any particles remain unclad, these too would be captured in the above described deposition process.

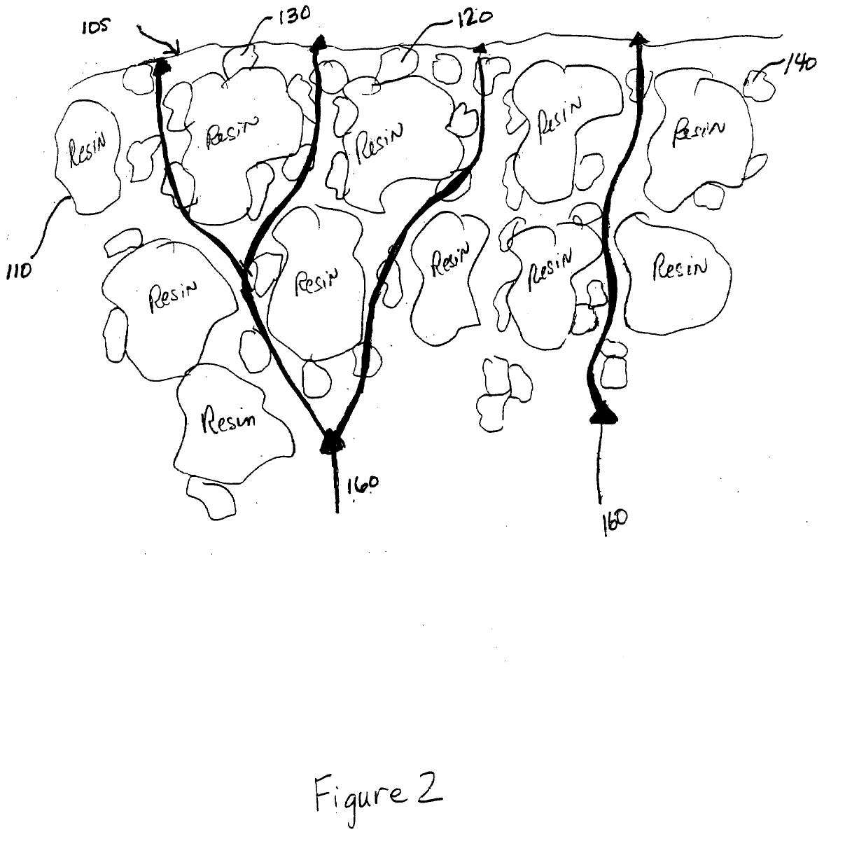

FIG. 2 illustrates one example of the arrangement of resin powder particles and active particles of the present invention. As shown in FIG. 2, (105) represents a depiction of a surface having the composition of the present invention thermally applied thereto. The surface represented in FIG. 2 contains resin particles (110), metal components (120), biocide particles (130) and fluoropolymers (140). The metal components (120), biocide particles (130) and fluoropolymers (140) of the applied composition shown in FIG. 2 are clad to the resin powder (110) molecules of the present invention. As one of the active particles at the surface is depleted, the next active particle behind the surface particle is free to leach to the surface and replace the depleted particle. This arrangement is referred to in the figure as the leaching passageway (160), which provides both active particles at the surface (105) of a structure, as well as, a reserve of active particles that can leach to the surface (105) once the surface particles are depleted.

It is noted however, that although the particles clad to the resin particles shown in FIG. 2 have metal components, biocides and fluoropolymers attached, it is understood the claimed polymer composition need not have all of these components, and can be produced with less than all of the components shown. What is also understood is that additional particles can be used in the present invention that provide color, strength, durability, shine, etc, all of which fall within the inventive aspect of the present invention.

In one embodiment of the present invention, the resin used in the coating composition is selected from the group consisting essentially of polyethylene powder, copolyamide powder, polyamide, such as Nylon 11, pebax, platamid powder, ethylene acrylic acid (EAA) powder ethylene maleacrylic acid (EMAA) and mixtures thereof. In one particular embodiment of the present invention, the resin particle is polyethylene powder.

The size of the resin particles of the present invention is important in providing a matrix of particles containing crevices/fissures (shown in FIG. 2) in which the active ingredients can leach to the surface of the coating. In other words, once applied, the composition produces a type of “particle passageway” from deep within the composition coating to the surface of the coating that allows for active ingredients to travel to the surface and replace any active particles that are removed and/or dissolved away from the surface. The resin particles of the present invention must have an average particle size less than about 180 microns, preferably an average particle size less than about 150 microns, more preferably an average particle size less than about 74 microns, and most preferably an average particle size less than about 45 microns. Expressing the average particle size in ranges, an average particle size from about 10 microns to about 100 microns is preferred and from about 20 microns to about 45 microns is most preferred.

As discussed above, the antifouling composition of the present invention may also contain at least one metal component. Examples of metal components that can be used in the present invention include, but are not limited to, zinc, copper, magnesium, calcium and barium. These metals can be in the form of metal oxides, such as cuprous oxide, cupric oxide and/or metal salts. On average, the weight percent of the metals in the antifouling composition of the present invention can range from about 1% by weight of the complete composition to about 80% by weight of the total composition, preferably form about 20% by weight of the complete composition to about 50% by weight of the total composition and more even more preferably from about 20% by weight of the total composition to about 40% by weight of the total composition.

As also stated above, the composition of the present invention may contain at least one biocide. A biocide is a compound that is capable of stopping the infestation of infestation-forming organisms, such as barnacles, worms, mussels and the like. Customary antifouling biocides are organotin compounds. Suitable biocides, in addition to heavy metal compounds, include algaecides, fungicides, insecticides, molluscicides and bactericides. Examples of biocides that can be used in the present invention include but are not limited to the following compounds:

Triazoles:

Azaconazole, bromuconazole, cyproconazole, dichlobutrazol, diniconazole, hexconazole, metconazole, penconazole, propiconazole, tebuconazole, amitrole, azocyclotin, epoxyconazole, bitertanol, difenoconazole, fenbuconazole, fenchlorazole, fenethanil, fluquinconazole, flusilazole, flutriafol, imibenconazole, isozofos, myclobutanil, paclobutrazol, (.+−.)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts.

Imidazoles such as, Imazalil, pefurazoate, prochloraz, triflumizole. hiazolecarboxanilides, such as 2′,6′-dibromo-2-methyl-4-trifluoromethoxy-4′-trifluoromethyl-1,3-thiazole-5-carboxanilide and their metal salts and acid adducts. Succinate dehydrogenase inhibitors, such as: Fenfuram, furcarbanil, cyclafluramid, furmecyclox, seedvax, metsulfovax, pyrocarbolid, oxycarboxin, Shirlan, mebenil (mepronil), benodanil, flutolanil (Moncut);

Naphthalene derivatives, such as: Terbinafine, naftifine, butenafine; 10,10′ oxybisphenoxarsine, Sulphenamides, such as dichlofluanid, tolylfluanid, folpet, fluorfolpet; captan, captofol; Benzimidazoles, such as carbendazim, benomyl, furathiocarb, fuberidazole, thiophonatmethyl, thiabendazole or salts thereof; Morpholine derivatives, such as tridemorph, fenpropimorph, falimorph, dimethomorph, dodemorph; aldimorph, fenpropidin and their salts with arylsulphonic acids, such as p-toluenesulphonic acid and p-dodecylphenyl-sulphonic acid; Dithiocarbamates, cufraneb, ferbam, mancopper, mancozeb, maneb, metam, metiram, thiram zeneb, ziram; Benzothiazoles, such as 2-mercaptobenzothiazole; Benzamides, such as 2,6-dichloro-N-(4-trifluoromethylbenzyl)-benzamide; Boron compounds, such as boric acid, boric esters, borax; Formaldehyde and formaldehyde donor compounds, such as benzyl alcohol mono-(poly)-hemiformal, oxazolidines, hexa-hydro-5-triazines, N-methylolchloracetamide, paraformadehyde, nitropyrine, oxolic acid, tecloftalam;

Tris-N-(cyclohexyldiazeniumdioxy)-aluminium, N-(cyclo-hexyldiazeniumdioxy)-tributyl, K salts; N-Methylisothiazolin-3-one, 5-chloro-N-methylisothiazolin-3-one, 4,5-dichloro-N-octylisothiazolin-3-one, N-octyl-isothiazolin-3-one, 4,5-trimethylene-isothiazolinone, 4,5-benzisothiazolinone; Aldehydes, such as cinnamaldehyde, formaldehyde, glutardialdehyde, .beta.-bromo-cinnamaldehyde; thiocyanates, such as thiocyanatomethylthiobenzothiazole, methylenebisthiocyanate, and the like;

Quaternary ammonium compounds, such as benzyldimethyltetradecylammonium chloride, benzyldimethyldodecylammonium chloride, didecyldimethylammonium chloride; Iodine derivatives, such as diiodomethyl p-tolyl sulphone, 3-iodo-2-propinyl alcohol, 4-chlorophenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl-n-butylurea, 3-iodo-2-propinyl n-hexylcarbamate, 3-iodo-2-propinyl cyclohexylcarbamate, 3-iodo-2-propinyl phenylcarbamate; Phenol derivatives, such as tribromophenol, tetrachlorophenol, 3-methyl-4-chlorophenol, 3,5-dimethyl-4-chlorophenol, phenoxyethanol, dichlorophen, o-phenylphenol, m-phenylphenol, p-phenylphenol, 2-benzyl-4-chlorophenol and their alkali metal salts and alkaline earth metal salts.

Microbicides having an activated halogen group, such as chloroacetamide, N-methylolchloroacetamide, bronopol, bronidox, tectamer such as 2-bromo-2-nitro-1,3-propanediol, 2-bromo-4′-hydroxy-acetophenone, 2,2-dibromo-3-nitrilo-propionamide, 1,2-dibromo-2,4-dicyanobutane, .beta.-bromo-.beta.-nitrostyrene; Pyridines, such as 1-hydroxy-2-pyridinethione (and the Na, Fe, Cu, Mn, Zn salts thereof), tetrachloro-4-methylsulphonylpyridine, pyrimethanol, mepanipyrim, dipyrithione; Dialkyldithiocarbamates, such as Na salts of dialkyldithiocarbamates, tetramethylthiuram disulphide, potassium N-methyl-dithiocarbamate; Nitriles, such as 2,4,5,6-tetrachloroisophthalonitrile, disodium cyano-dithioimidocarbamate; Quinolines, such as 8-hydroxyquinoline and the Cu salts thereof; Mucochloric acid, 5-hydroxy-2(5H)-furanone; 4,5-Dichlorodithiazolinone, 4,5-benzodithiazolinone, 4,5-trimethylenedithiazolinone, 4,5-dichloro-(3H)-1,2-dithiol-3-one, 3,5-dimethyl-tetrahydro-1,3,5-thiadiazine-2-thione, N-(2-p-Chlorobenzoylethyl)-hexaminium chloride, potassium N-hydroxymethyl-N′-methyl-dithiocarbamate, 2-Oxo-2-(4-hydroxy-phenyl)acethydroximic acid chloride, Phenyl 2-chloro-cyano-vinyl sulphone, Phenyl 1,2-dichloro-2-cyano-vinyl sulphone.

Furthermore, highly effective compositions are also prepared with the following active substances:

Fungicides:

Methyl(E)-methoximino[.alpha.-(o-tolyloxy)-o-tolyl]acetate, methyl(E)-2-{2-[6-(2-cyanophenoxy)-pyrimidin-4-yl-oxy]phenyl}-3-methoxyacrylate, Acypetacs, 2-aminobutane, ampropylfos, anilazine, benalaxyl, bupirimate, chinomethionat, chloroneb, chlozolinate, cymoxanil, dazomet, diclomezine, dichloram, diethofencarb, dimethirimol, diocab, dithianon, dodine, drazoxolon, edifenphos, ethirimol, etridiazole, fenarimol, fenitropan, fentin acetate, fentin hydroxide, ferimzone, fluazinam, fluorormide, flusulfamide, flutriafol, fosetyl, fthalide, furalaxyl, guazatine, hymexazol, iprobenfos, iprodione, isoprothiolane, metalaxyl, methasulfocarb, nitrothal-isopropyl, nuarimol, ofurace, oxadiyl, perflurazoate, pencycuron, phosdiphen, pimaricin, piperalin, procymidone, propamocarb, propineb, pyrazophos, pyrifenox, pyroquilon, quintozene, tar oils, tecnazene, thicyofen, thiophanate-methyl, tolclofos-methyl, triazoxide, trichlamide, tricyclazole, triforine, vinclozolin.

Insecticides:

Phosphates, such as azinphos-ethyl, azinphos-methyl, .alpha.-1(4-chlorophenyl)-4-(O-ethyl, S-propyl)phosphoryloxy-pyrazole, chlorpyrifos, coumaphos, demeton, demeton-S-methyl, diazinon, dichlorvos, dimethoate, ethoate, ethoprophos, etrimfos, fenitrothion, fenthion, heptenophas, parathion, parathion-methyl, phosalone, phoxim, pirimiphos-ethyl, pirimiphos-methyl, profenofos, prothiofos, sulfprofos, triazophos and trichlorphon;

Carbamates, such as aldicarb, bendiocarb, .alpha.-2-(1-methylpropyl)-phenyl methylcarbamate, butocarboxim, butoxycarboxim, carbaryl, carbofuran, carbosulfan, cloethocarb, isoprocarb, methomyl, oxamyl, pirimicarb, promecarb, propoxur and thiodicarb;

Organosilicon compounds, preferably dimethyl(phenyl)silyl-methyl 3-phenoxybenzyl ethers such as dimethyl-(4ethoxyphenyl)-silylmethyl 3-phenoxybenzyl ether, or

(dimethylphenyl)-silyl-methyl 2-phenoxy-6-pyridylmethyl ethers, such as e.g. dimethyl-(9-ethoxy-phenyl)-silylmethyl 2-phenoxy-6-pyridylmethyl ether or [(phenyl)-3-(3-phenoxyphenyl)-propyl](dimethyl)-silanes, such as e.g. (4-ethoxyphenyl)-[3-(4-fluoro-3-phenoxyphenyl-propyl]dimethyl-silane, silafluofen; Pyrethroids, such as allethrin, alphamethrin, bioresmethrin, byfenthrin, cycloprothrin, cyfluthrin, decamethrin, cyhalothrin, cypermethrin, deltamethrin, alpha-cyano-3-propancarboxylate, fenpropathrin, fenfluthrin, fenvalerate, flucythrinate, flumethrin, fluvalinate, permethrin, resmethrin and tralomethrin; Nitroimines and nitromethylenes, such as 1-[(6-chloro-3-pyridinyl)-methyl]-4,5-dihydro-N-nitro-1H-imidazole-2-amine(imidacloprid), N-[(6-chloro-3-pyridyl)methyl-]N.sup.2-cyano-N.sup.1-methylacetamide(NI-25);

Abamectin, AC 303, 630, acephate, acrinathrin, alanycarb, aldoxycarb, aldrin, amitraz, azamethiphos, bacillus thuringiensis, phosmet, phosphamidon, phosphine, prallethrin, propaphos, propetamphos, prothoate, pyraclofos, pyrethrins, pyridaben, pyridafenthion, pyriproxyfen, quinalphos, RH-7988, rotenone, sodium fluoride, sodium hexafluorosilicate, sulfotep, sulphuryl fluoride, tar oils, teflubenzuron, tefluthrin, temephos, terbufos, tetrachlorvinphos, tetramethrin, O-2-tert-butyl-pyrimidin-5-yl-o-isopropyl-phosphorothiate, thiocyclam, thiofanox, thiometon, tralomethrin, triflumuron, trimethacarb, vamidothion, verticillium lacanii, XMC, xylylcarb, benfuracarb, bensultap, bifenthrin, bioallethrin, MERbioallethrin (S)-cyclopentenyl isomer, bromophos, bromophos-ethyl, buprofezin, cadusafos, calcium polysulphide, carbophenothion, cartap, chinomethionat, chlordane, chlorfenvinphos, chlorfluazuron, chlormephos, chloropicrin, chlorpyrifos, cyanophos, beta-cyfluthrin, alpha-cypermethrin, cyophenothrin, cyromazine, dazomet, DDT, demeton-5-methylsulphon, diafenthiuron, dialifos, dicrotophos, diflubenzuron, dinoseb, deoxabenzofos, diaxacarb, disulfoton, DNOC, empenthrin, endosulfan, EPN, esfenvalerate, ethiofencarb, ethion, etofenprox, fenobucarb, fenoxycarb, fensulfothion, fipronil, flucycloxuron, flufenprox, flufenoxuron, fonofos, formetanate, formothion, fosmethilan, furathiocarb, heptachlor, hexaflumuron, hydramethylnon, hydrogen cyanide, hydroprene, IPSP, isazofos, isofenphos, isoprothiolane, isoxathion, iodfenphos, kadethrin, lindane, malathion, mecarbam, mephosfolan, mercurous, chloride, metam, Metarthizium, anisopliae, methacrifos, methamidophos, methidathion, methiocarb, methoprene, methoxychlor, methyl isothiocyanate, metholcarb, mevinphos, monocrotophos, naled, Neodiprion sertifer NPV, nicotine, omethoate, oxydemeton-methyl, pentachlorophenol, petroleum oils, phenothrin, phenthoate, phorate;

Molluscicides: Fentin acetate, metaldehyde, methiocarb, niclosamide, thiodicarb, trimethacarb;

Algicides: Dichlororphen, endothal, fentin acetate, quinoclamine; Herbicides: Diuron, dichlorophen, endothal, fentinacet, quinochlamine.

Additional suitable biocides are preferably algicides, such as diuron, dichlorophen, endothal, fentin acetate, quinoclamine, molluscicides, such as fentin acetate, metaldehyde, methiocarb, niclosamide, thiodicarb and trimethacarb, fungicides, such as dichlofluanid, tolylfluanid, iodopropargyl butylcarbamate, fluorfolpet and azoles, such as tebuconazole or customary antifouling active substances, such as 2-(N,N-dimethylthiocarbamoylthio)-5-nitrothiazyl, tetrabutyldistannoxane, 2-tert-butylamino-4-cyclopropylamino-6-methylthio-1,3,5-triazine, 4,5-dichloro-2-n-octyl-4-isothiazolin-3-one, 2,4,5,6-tetrachloroisophthalonitrile, tetramethylthiuram disulphide, 2,4,6-trichlorophenylmaleimide, 2,3,5,6-tetrachloro-4-(methylsulphonyl)-pyridine, diiodomethyl paratryl sulphone, thiabendazole, tetraphenylboron pyridine salt, sodium salt of 2-pyridinethiol 1-oxide.

In addition, either alone or in combination with one of the above-referenced biocides, silver ion may be used. For example, silver ions available from Agion, Inc. may be used in various concentrations to provide biocide activity to the coating.

In addition to underwater use, compositions containing the above-reference biocides, in addition to heavy metal compounds, that include algaecides, fungicides, insecticides, molluscicides and bactericides may or may not be used in fully submerged environments or may be used in environments that often become wet. For example, a food-processing environment that routinely gets washed down and where fungi, as well as other bacterial growth, must be kept to a minimum is one intended use for present invention.

Particularly good effects are also obtained with active-substance combinations preferably of the specified biocides. Particular preference is given to those biocides which are biodegradable.

The antifouling coating composition of the present invention may further comprises at least one of the following, zinc oxide as a coating film strength increasing agent, a coating film consumption regulator, a body pigment such as colorant, or a color pigment, or an elution accelerating component or mixture thereof.

The antifouling coating film of the present invention is characterized in that it is formed from any of the coating compositions of the present invention described herein.

The present invention is also directed to and underwater structure coated with a film of the present invention. The structures may include fishing gear, fishing nets, pilings, docks, chain, moorings and the like each having a surface covered with the at least one antifouling coating film formed from any of the antifouling coating compositions described herein.

The method of rendering a marine vessel, an underwater structure, fishing gear or fishing nets antifouling according to the present invention comprises applying any of the antifouling coating compositions described herein to a surface of base material of a marine vessel, an underwater structure, fishing gear or fishing net and drying the applied antifouling coating composition so that a formed antifouling coating film covers the base material surface.

When the antifouling blend of the present invention is thermally sprayed, the clad resin particles, for example polyethylene resins, with cuprous oxide and biocide, are dispersed throughout the coating with the active constituents confined to the periphery of the resin particles also dispersed. The antifouling coating produced has a higher integrity than existing antifouling paint coatings and provides antifouling properties for several years.

As stated above, the availability of the active additives in the antifouling coating of the present invention to leach to the surface allows for depleted surface active ingredients to be easily replenished. In other words, the active ingredients attached, i.e., cladded, to the resin molecules are available to migrate by capillary action through the coating matrix to provide a reservoir of active ingredients that will be available at the surface once the surface active ingredients are depleted.

The thermally sprayed coating of the present invention can be applied in a thickness of from about 0.001 inches to greater than about 0.010 inches, a thickness much thicker than conventional applied coatings such as paints. This ability to put thick coatings, without peeling, in addition to the aspects of the invention described above, provides a coating having long lasting protection.

The present invention provides an antifouling coating composition which ensures better storage stability than paint, and from which there can be obtained an antifouling coating film that exhibits less cracking tendency, better adherence so as to ensure less peeling tendency than paints available on the market today. In addition to these benefits, the claims compositions also have a desirably controlled hydrolysis rate so as to maintain excellent antifouling performance for long-term antifouling properties. In particular, antifouling properties on structures that are constantly subjected to organisms such as submerged stationary structures in highly fouling environments.

The present thermally sprayable compositions can be made by blending the resin particles in powdered form with at least one component selected from the group consisting of metal containing compounds, biocide, fluoropolymer and mixtures thereof in a conventional mixer used in the filed of polymer chemistry. As described above, the amount of resin powder used in making the composition is greater than the other components used so as to assure that the resin particles are incompletely coated and therefore melt and adhere to a surface prior to scorching during the thermal spraying process.

The composition may also be manufactured using a binder to make the cladding process more efficient. In this procedure, the resin particles become wet with the binder and at least one of the other components listed in the disclosure above is added to the composition. The other components added to the wet resin particles actually stick to the resin particles and form particles clad with other components. The composite particles produced are only partially clad, partial clad being controlled by adding an excess of resin particles to other components during this production process. Conventional stirring mixtures used in polymer chemistry can be used for this mixing process. The size of the particles in the final mixture can be controlled by passing the final powder composition through a screen/sieve having a desired particle diameter size.

One particular metal component that is added to the resin is Cupric or Cuprous oxide having an average particle size between about 1 micron to about 40 microns, 1 micron to 20 microns, with a preferred average particle size of about 3 microns.

While the preferred embodiment of the present invention has been illustrated and described in detail, various modifications of, for example, components, materials and parameters, will become apparent to those skilled in the art, and all such modifications and changes are intended to fall within the scope of the claims of the present invention.

What is claimed is:

1. A thermally sprayable polymer coating composition comprising:
(i) at least one resin powder; and
(ii) at least one component selected from the group consisting of metal containing compound, biocide, fluoropolymer and mixtures thereof.

2. The thermally sprayable polymer coating composition of claim 1, wherein at least one component of step (ii) is clad to said resin powder to produce a clad component particle comprising at least one resin clad to at least one additional component.

3. The thermally sprayable polymer coating composition of claim 1 further comprising at least one binding solution for cladding said at least one component to said resin powder.

4. The thermally sprayable polymer coating composition of claim 3 wherein the binding solution is water-soluble.

5. The thermally sprayable polymer coating composition of claim 1, wherein said resin powder is selected from the group consisting of polyethylene (PE) powder, polyamide powder, pebax, platamid powder, ethylene acrylic acid (EAA), ethylene maleacrylic acid (EMAA) epoxy, polyester powder and powder mixtures thereof.

6. The thermally sprayable polymer coating composition of claim 4 wherein said water soluble binding solution is selected from the group consisting of ethylene glycol, potato starch, polyvinyl pyrrolidinone, butylated polyvinyl pyrrolidinone, and mixtures thereof.

7. The thermally sprayable polymer coating composition of claim 1, wherein said metal compound is selected from the group consisting of cuprous oxide, cupric oxide, copper powder, oxine copper, organocopper compounds, organonickel compounds, zinc sulfate, zinc oxide and zinc pyrithione, other organozinc compounds and mixtures thereof.

8. The thermally sprayable polymer coating composition of claim 7, wherein said metal compound is cuprous oxide or cupric oxide.

9. The thermally sprayable polymer coating composition of claim 2, wherein said clad resin particles have an average particle size of less than about 180 microns.

10. The thermally sprayable polymer coating composition of claim 2, wherein said clad resin particles have an average particle size of less than about 150 microns.

11. The thermally sprayable polymer coating composition of claim 2, wherein said clad resin particles have an average particle size of less than about 140 microns.

12. The thermally sprayable polymer coating composition of claim 2, wherein said clad resin particles have an average particle size of less than about 45 microns.

13. The thermally sprayable polymer coating composition of claim 2, wherein said clad resin particles have an average particle size of from about 10 microns to about 100 microns.

14. The thermally sprayable polymer coating composition of claim 2, wherein said clad resin particles have an average particle size of from about 30 microns to about 100 microns.

15. The thermally sprayable polymer coating composition of claim 2, wherein said clad resin particles have an average particle size of less than about 20 microns to about 45 microns.

16. The thermally sprayable polymer coating composition of claim 1, wherein the resin powder is polyethylene (PE).

17. The thermally sprayable polymer coating composition of claim 1, wherein said metal compound is contained in an amount of about 1% by weight of the total composition to about 80% by weight of the total composition.

18. The thermally sprayable polymer coating composition of claim 1, wherein said metal compound is contained in an amount of about 20% by weight of the total composition to about 50% by weight of the total composition.

19. The thermally sprayable polymer antifouling coating composition of claim 1, further comprising additional agents such as filler, pigments, preservative, fibers and mixture thereof.

20. A thermally sprayed film formed from the coating composition of claim 1.

21. A structure coated with said thermally sprayed film of claim 19.

22. A method of coating a surface with a thermally sprayed polymer composition comprising applying said thermally sprayable polymer composition of claim 1 to a surface to produce a surface wherein at least a portion of said surface is coated with said thermally sprayable polymer composition.

23. The thermally sprayable polymer coating composition of claim 1, wherein the percent by volume of the resin powder in said composition is greater than the weight percent by volume of the components in step (ii) in the composition so that at least a portion of the resin powder remains unclad.

24. The thermally sprayable polyene coating component of claim 1, wherein said resin powder and said at least one component of step (ii) is combined to form a agglomerated composite of the components of step (ii) and resin.

25. The thermally sprayable coating composition of claim 1, wherein the composition is in a powdered particulate form.

26. The thermally sprayable coating composition of claim 2 wherein said clad resin particles have an average particle size of about 30 microns.
